(19) United States
(12) Patent Application Publication
(10) Pub. No.: US 2002/0082729 A1
(43) Pub. Date: Jun. 27, 2002

(54) PC card connector assembly

(76) Inventor: Hui Wen Tsao, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/023,662

(22) Filed: Dec. 21, 2001

(30) Foreign Application Priority Data
Dec. 27, 2000 (CN) 00266445.3

(51) Int. Cl. G06F 17/00

(52) U.S. Cl. 700/90

(57) ABSTRACT

A PC card connector assembly comprises a first connector and a second connector. The first connector has an upper row of terminal holes and a lower row of terminal holes at front side thereof. A row of terminal grooves are formed below one row of terminal holes and each row of terminal grooves receives a row of terminals mated with a PC card. The first connector has two elastic arms extended therefrom and an elastic plate is connected to bottom of the elastic arm to elevate the first connector such that the first connector will not block other components of the notebook computer and the assembling of a second connector can be facilitated.

### FIELD OF THE INVENTION

The present invention relates to a PC card connector assembly, especially to a PC card connector assembly with a means to elevate a first connector such that the first connector will not block other components of the notebook computer and the assembling of a second connector can be facilitated.

### BACKGROUND OF THE INVENTION

The notebook computers have compact size and light weight to provide portability for users. However, the notebook computers generally suffer to problem of update ability and are usually provided with PC card slots for mounting various PC cards to expand the function thereof.

The prior art notebook computers generally have only one PC card slot. Therefore, the PC cards are connected in series to the notebook computer to expand the memory size or provide more peripheral for the notebook computers.

The more advanced notebook computers are provided PC card connector with two-slots for adapting more PC cards.

However, the two slots of above-mentioned PC card connector are arranged in juxtaposed or stacked fashion. The juxtaposed (stacked) slots together with the inserted memory cards or PC cards further increase the weight of the notebook computers.

### SUMMARY OF THE INVENTION

It is an object of the present invention to provide a PC card connector assembly, wherein two connectors are provide to enhance the expansion ability of the notebook computer.

It is another object of the present invention to provide a PC card connector assembly, wherein two connectors are stacked and have partial overlap area such that the notebook computer using the inventive PC card connector assembly still has compact size.

To achieve above object, the present invention comprises a PC card connector assembly comprising a first connector and a second connector. The first connector has an upper row of terminal holes and a lower row of terminal holes at front side thereof. A row of terminal grooves are formed below one row of terminal holes and each row of terminal grooves receives a row of terminals mated with a PC card. The first connector has two elastic arms extended therefrom and an elastic plate is connected to bottom of the elastic arm to elevate the first connector such that the first connector will not block other components of the notebook computer and the assembling of a second connector can be facilitated.

The various objects and advantages of the present invention will be more readily understood from the following detailed description when read in conjunction with the appended drawing, in which:

### BRIEF DESCRIPTION OF DRAWING

FIG. 1 shows an exploded perspective view of the first connector of the PC card connector assembly according to the present invention;

FIG. 2 shows a perspective view of the first connector of the PC card connector assembly according to the present invention,

FIG. 3 shows an exploded perspective view of the second connector of the PC card connector assembly according to the present invention;

FIG. 4 shows a perspective view of the second connector of the PC card connector assembly according to the present invention;

FIG. 5 shows a perspective view of the present inventions;

FIG. 6 shows an exploded view of the present inventions;

FIG. 7 shows an exploded view of the present inventions, wherein partial components are assembled;

FIG. 8 shows another perspective view of the present inventions;

FIG. 9 shows a top view of the present inventions; and

FIG. 10 shows a sectional view of the present inventions.

### DETAILED DESCRIPTION OF THE INVENTION

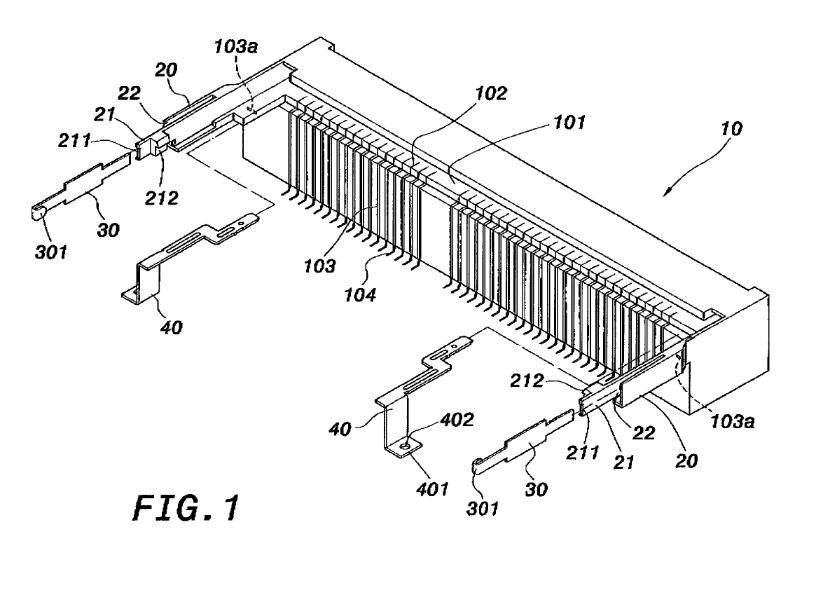

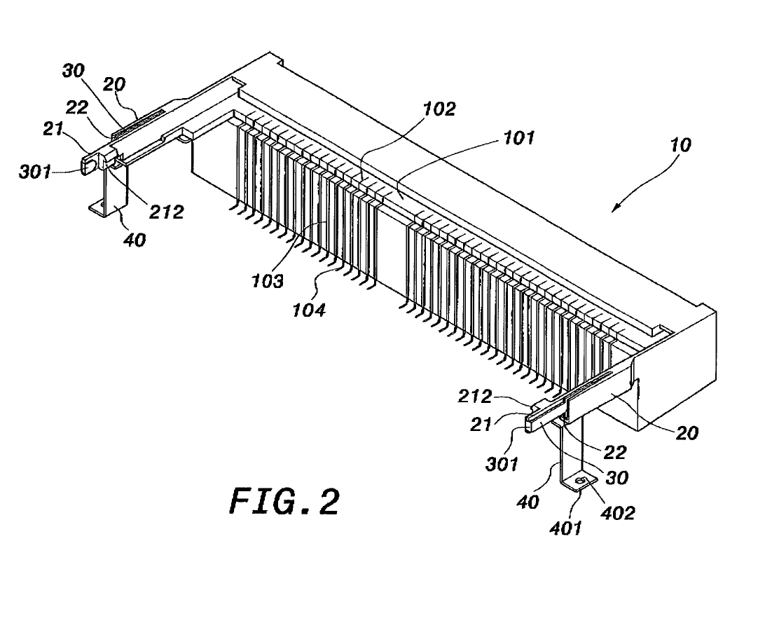

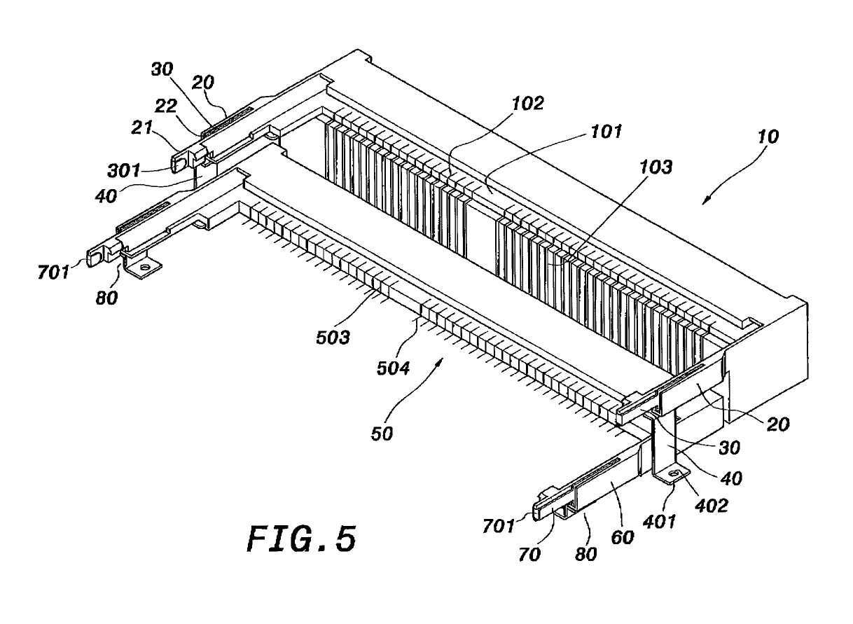

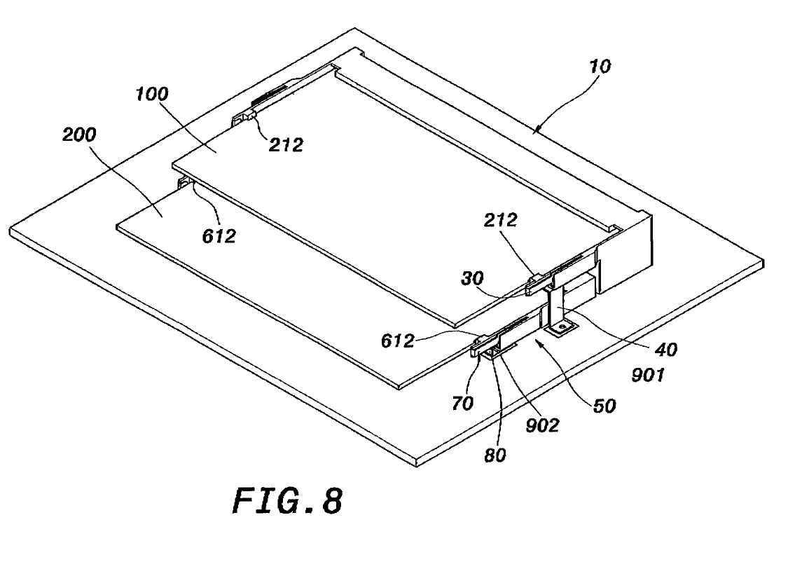

With reference to FIGS. 1 and 2, the present invention provides a PC card connector assembly, especially provides a PC card connector assembly adapted for two PC cards and used for notebook computers The inventive PC card connector assembly comprises a first connector 10 with a recess 101 on topside thereof. The recess 101 has two rows (upper row and lower row) of terminal holes 102 (the upper row of terminal holes are not shown). The lower row of terminal holes 102 has a row of terminal grooves 103 below it. The terminal grooves 103 have two dents 103a on both sides thereof. A plurality of terminals 104 are arranged within the terminal grooves 103. Each of the terminals 104 has one end extending out of the terminal grooves 103. The first connector 10 has two coupling members 20 extending from both sides thereof and each having L-shape. One side of the coupling member 20 is connected to an elastic arm 21; and each elastic arm 21 has a notch 211 at distal end thereof and a bump 212 on inner side thereof. A gap 22 is formed between each coupling member 20 and each elastic arm 21, A retaining plate 30 has one end inserted to the gap 22 and another end having a hook 301 engaged to the notch 211. The coupling member 20 has an elastic plate 40 on bottom thereof. The elastic plate 40 has one end embedded into the dents 103a on both sides of the terminal grooves 103 and another end with a flange 401. The flange 401 has a rounded hole 402 thereon to enhance soldering strength. The elastic plate 40 is used to elevate the first connector 10 such that the first connector 10 will not block other components of the notebook computer and the assembling of a second connector 50 (as shown in FIG. 5) can be facilitated. As shown in FIG. 8, the assembled first connector 10 and the second connector 50 can be used to adapt for two PC cards 100 and 200 to enhance the memory size and function of the notebook computer.

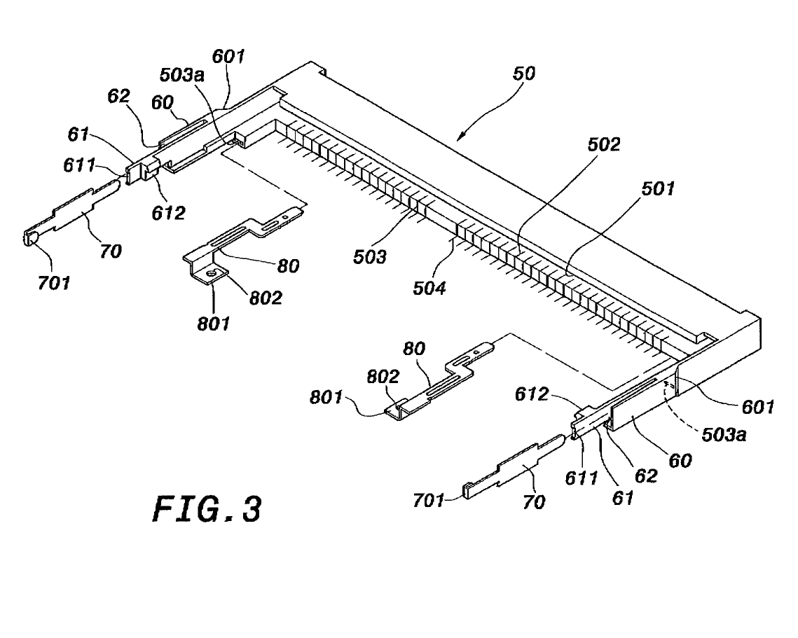

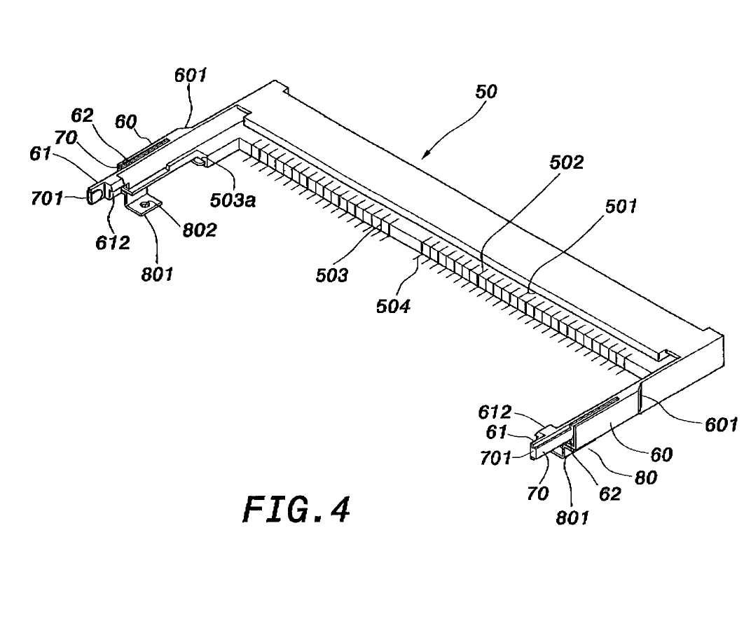

With reference to FIGS. 3 and 4, the inventive PC card connector assembly further comprises a second connector 50 with a recess 501 on topside thereof. The recess 501 has two rows (upper row and lower row) of terminal holes 502 (the upper row of terminal holes are not shown), The lower row of terminal holes 502 has a row of terminal grooves 503 below it. The terminal grooves 503 have two dents 503a on both sides thereof. A plurality of terminals 504 are arranged within the terminal grooves 503. Each of the terminals 504 has one end extending out of the terminal grooves 503. The second connector 50 has two coupling members 60 extending from both sides thereof and each having L-shape, The coupling member 60 has an h-shaped bevel 601 on an outer center side thereof. One side of the coupling member 60 is connected to an elastic arm 61; and each elastic arm 61 has a notch 611 at distal end thereof and a bump 612 on inner side thereof, A gap 62 is formed between each coupling member 60 and each elastic arm 61. A retaining plate 70 has one end inserted to the gap 62 and another end having a hook 701 engaged to the notch 611. The coupling member 60 has an elastic plate 80 on bottom thereof. The elastic plate 80 has one end embedded into the dents 503a on both sides of the terminal grooves 503. The elastic plate 80 has an L-shaped bottom layer 801 on bottom thereof and having a rounded hole 802 thereon to enhance soldering strength.

With reference now to FIGS. 1 to 5, in the inventive PC card connector assembly, the first connector 10 and the second connector 50 can be separately formed, or integrally formed by injection molding. Moreover, the terminal grooves 103 of the first connector 10 are higher than the terminal grooves 503 of the second connector 50. In other word, the second connector 50 is placed below the first connector 10 and the front edge of the bevel 601 of the second connector 50 is laid against the inner side of the elastic plate 40 of the first connector 10, thus assembling the first connector 10 and the second connector 50.

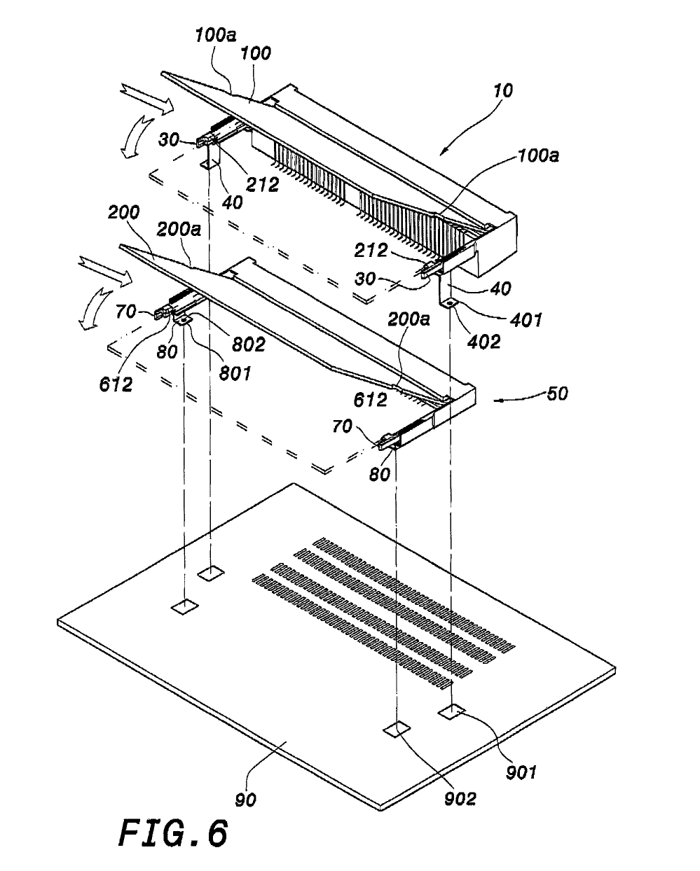

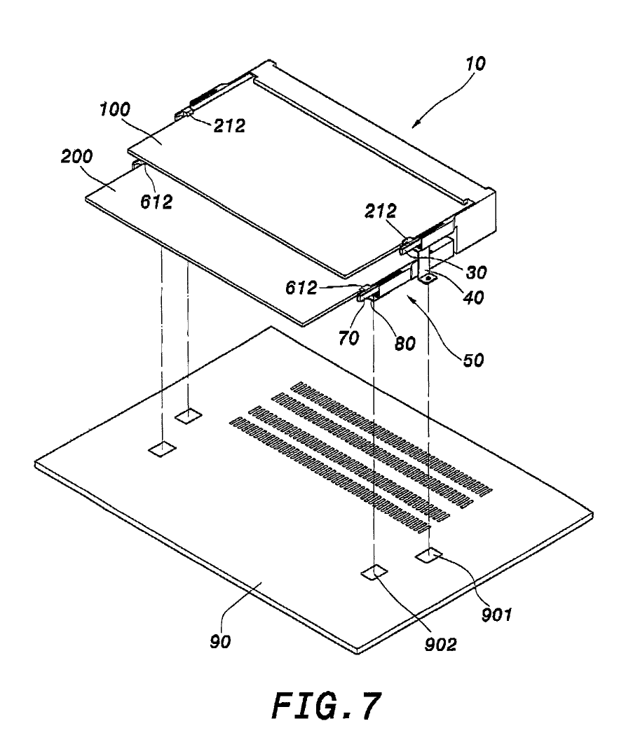

With reference now to FIGS. 5 to 7, after the assembling of the first connector 10 and the second connector 50, the first connector 10 and the second connector 50 are soldered to a circuit board 90. More particularly, the flange 401 and the L-shaped bottom layer 801 are soldered to corresponding first solder spots 901 and second solder spots 902 on the circuit board 90. Afterward, the first PC card 100 and the second PC card 200 are inserted into the recesses 101 and 501 along an angle of 45°. The first PC card 100 and the second PC card 200 are then pressed such that contacts (not shown) of the first PC card 100 and the second PC card 200 are connected to corresponding terminals The first PC card 100 and the second PC card 200 have indentations 100a and 200a on both sides thereof and fit into the bumps 212 and 612 of the first connector 10 and the second connector 50, thus finishing the arrangement of the first PC card 100 and the second PC card 200 as shown in FIG. 8.

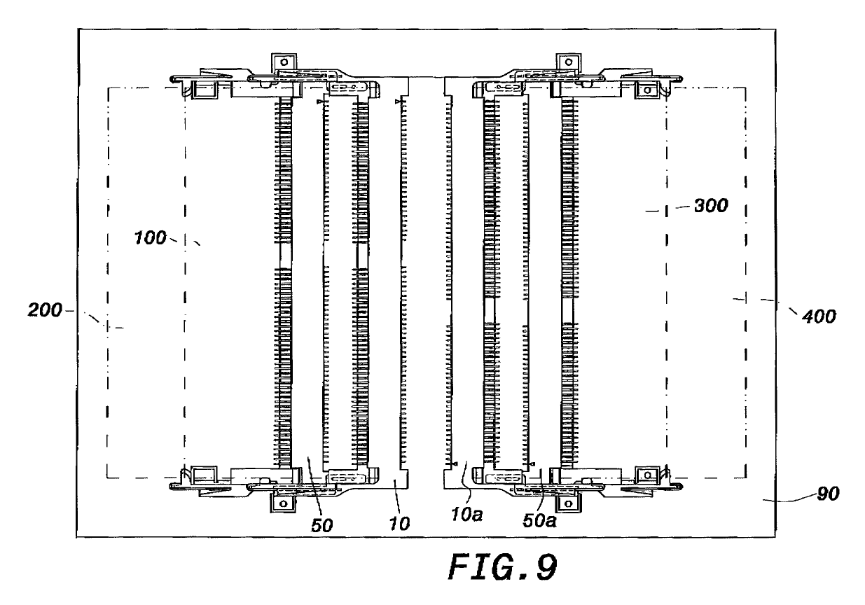

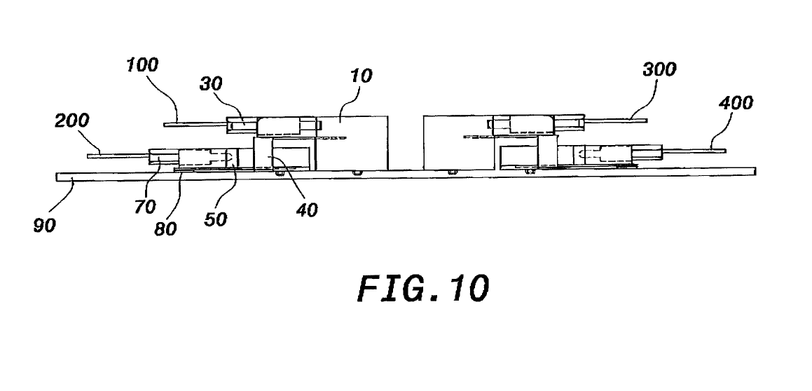

FIGS. 9 and 10 show another preferred embodiment of the present invention, wherein the PC card connector assembly is used for notebook computer demanding more versatile functions. The PC card connector assembly comprises a first connector 10, a second connector 50, a third connector 10a and a fourth connector 50a for adapting to a first PC card 100, a second PC card 200, a third PC card 300 and a fourth PC card 400, respectively. The connectors have similar structure as previous description and the PC cards have similar assembling way as previous description, whereby the notebook computer equipped with those connectors and PC cards has more versatile functions.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A PC card connector assembly comprising:
a first connector having an upper row of terminal holes and a lower row of terminal holes, a row of terminal grooves being formed below one row of terminal holes, each of the terminal groove receiving a terminal and two dents being provided on both side of the row of the terminal grooves; and
two elastic plates, each of the elastic plates having one end engaged into the dent to elevate the first connector.

2. The PC card connector assembly as in claim 1, wherein the first connector is integrally formed.

3. The PC card connector assembly as in claim 1, wherein the first connector is formed by injection molding.

4. The PC card connector assembly as in claim 1, wherein the number of the connector can be augmented to four.
